(19) United States
(12) Patent Application Publication
(10) Pub. No.: US 2013/0136816 A1
(43) Pub. Date: May 30, 2013

(54) APPARATUS FOR NON-DESTRUCTIVELY INSPECTING A CONVEYOR BELT DURING MANUFACTURE THEREOF UTILIZING HIGH-ENERGY RAYS

(71) Applicant: PHOENIX CONVEYOR BELT SYSTEMS GMBH, Bad Blankenburg (DE)

(72) Inventor: Bernd Kuesel, Hamburg (DE)

(73) Assignee: PHOENIX CONVEYOR BELT SYSTEMS GMBH, Bad Blankenburg (DE)

(21) Appl. No.: 13/751,827

(22) Filed: Jan. 28, 2013

Related U.S. Application Data
(63) Continuation of application No. PCT/EP2011/056537, filed on Apr. 26, 2011.

(30) Foreign Application Priority Data
Jul. 27, 2010 (DE) 10 2010 036 637.4

(51) Int. Cl. G01N 23/18; G01N 23/16

(52) U.S. Cl. CPC G01N 23/18; G01N 23/16
USPC 425/29; 378/58

(57) ABSTRACT

An apparatus non-destructively inspects a conveyor belt in a production facility. The conveyor belt defines a belt surface and has cover plates made of a rubber mixture. The production facility includes a vulcanizing press for vulcanizing the conveyor belt during production thereof. The apparatus includes a housing forward or rearward of the press. The housing has openings through which the conveyor belt passes. A radiation source mounted in the housing transmits rays toward the belt surface and the radiation source is configured to transmit the rays with energy sufficient to cause the rays to pass through the conveyor belt. A sensor mounted in the housing detects the rays passed through the conveyor belt to facilitate a radiographic check by providing actual values of the conveyor belt. A processor evaluates the radiographic check by comparing the actual values of the conveyor belt to set values of the conveyor belt.

### CROSS REFERENCE TO RELATED APPLICATIONS

This application is a continuation application of international patent application PCT/EP2011/056537, filed Apr. 26, 2011, designating the United States and claiming priority from German application 10 2010 036 637.4, filed Jul. 27, 2010, and the entire content of both applications is incorporated herein by reference.

### FIELD OF THE INVENTION

The invention relates to an apparatus for non-destructively inspecting a conveyor belt in a manufacturing facility. The conveyor belt has a carrying-side cover plate and a running-side cover plate each made of a rubber mixture and has an embedded tension member. The manufacturing facility comprises at least the following facility components: a vulcanizing press including an upper platen and a lower platen, which can be heated; a first winding unit for the unvulcanized conveyor belt blank, which is fed to the vulcanizing press by unwinding; a second winding unit, which receives and rolls up the vulcanized conveyor belt after it has left the vulcanizing press; carrying rollers for the conveyor belt; and, a process computer.

### BACKGROUND OF THE INVENTION

In relation to the structure of a conveyor belt, reference is made in particular to the following patent literature: DE 25 20 943 A1; DE 25 32 190 A1; DE 38 01 120 A1; U.S. Pat. No. 5,460,261; DE 44 36 042 A1; EP 0 336 385 A1; U.S. Pat. No. 5,609,242; and, WO 2008/034483 A1.

The carrying-side cover plate and running-side cover plate each comprise a rubber mixture, containing a rubber component or a rubber component blend, a wetting agent or a wetting system comprising a wetting agent and an accelerator, and usually further mixture ingredients, in particular a filler and/or a processing aid and/or an ageing prevention agent and/or a plasticizer and/or other additives (for example, fibers, colored pigments). The relevant rubber base is in particular:

natural rubber (NR)
butadiene rubber (BR)
chloroprene rubber (CR)
styrene-butadiene rubber (SBR)
nitrile rubber (NBR)
butyl rubber (IIR)
ethylene-propylene rubber (EPM)
ethylene-propylene-diene rubber (EPDM)
SBR/NR blend
SBR/BR blend
NR/BR blend

Of particular importance until now was CR, which is distinguished by high resistance to flame, weathering and ageing, in particular for conveyor belts with use in underground mining. Nowadays, major importance is assigned to the material base SBR/NR.

As a result of the vulcanization of a rubber mixture of the aforementioned type, the conveyor belt experiences the necessary elastic properties.

The embedded tension member or reinforcement used is cords made of steel or aramid extending in the conveyor belt longitudinal direction, cords made of steel being of particular importance. In particular in conjunction with steel cord conveyor belts, embedded transverse reinforcement made of synthetic cords, for example of polyamide (PA), is additionally used for the purpose of split prevention (WO 2008/034483 A1). The tensile member or reinforcement can also be a textile fabric, in particular a single-layer or multilayer fabric, for example a polyester-polyamide fabric.

In addition, the following components can also be embedded in the carrying-side and/or running-side cover plate/s: conductor loops, transponders, bar codes, a polymer matrix with detectable particles mixed in or other detectable elements. In this regard, reference is made in particular to the following patent literature: DE 44 44 264 C1; DE 197 15 703 A1; U.S. Pat. No. 7,954,632; and, U.S. Pat. No. 6,781,515.

During the production of a conveyor belt, in addition to the visual monitoring, process-controlled devices for monitoring production areas are also used, for example when monitoring the vulcanization temperature.

In DE 10 2009 003 458 A1, a recent development for monitoring the cord tension of a steel cord conveyor belt during the production thereof is described. The monitoring device comprises at least the following components: a clamping device, which clamps all the cords; a measuring device, which monitors the cord tension of each cord; and, a cord tensioning device which, following evaluation of the measured results from the measuring device, is capable of performing re-tensioning individually as required on each cord.

Here, the measuring device is a sound level measuring station which is equipped with at least one sound pick-up which, for each coil that is set in oscillation, measures a change in the oscillation frequency and therefore, by comparison of the sound level, a change in the cord tension.

In past years, however, most development work has been invested in monitoring a running conveyor system which, given troughed or closed conveyor belt guidance, can extend over several kilometers. In particular, opto-electronic monitoring systems and radiation monitoring systems were used. These systems are described in the patent publication listed below.

### Opto-Electronic Systems

U.S. Pat. No. 6,702,103;
U.S. Pat. No. 6,831,566;
United States patent application publication 2003/0000808;
DE 101 29 091 A1;
DE 101 40 920 A1;
EP 1 187 781 B1;
U.S. Pat. No. 7,259,854; and,
WO 2008/031648 A1.

### Radiation Systems

DE 35 17 314 A1;
U.S. Pat. No. 8,149,989;
JP 04158208 A (Patent abstracts of Japan); and,
JP 2000292371 A (Patent abstracts of Japan).

### SUMMARY OF THE INVENTION

An object of the invention is, then, to provide a generic apparatus in such a way that all conveyor belt-specific data and also defects during the production of a conveyor belt can be detected reliably herewith.

This object is achieved in that a housing is arranged upstream and/or downstream of the vulcanizing press and is provided with two housing openings through which the conveyor belt runs without contact, wherein a radiation source emits rays within the housing in the direction of the surface of the conveyor belt. These rays contain such a high amount of energy that they pass through the conveyor belt. A sensor likewise accommodated in the housing detects the rays which have passed through without contact. The process computer finally evaluates the result of the radiographic check by detecting the actual values and comparing the same with the nominal or set values of the conveyor belt.

The radiation source emits especially x-rays and here, the radiation source is in the form of an x-ray tube. Within the housing, the radiation source is arranged in such a way that the belt surface can be covered by the rays in accordance with the following two variants I or II described below.

### Variant I

The radiation source covers the entire conveyor belt width. This is preferably the case when the conveyor belt is not excessively wide, for example up to 1000 mm.

### Variant II

Large overland conveyor belts are generally up to 2800 mm wide. Since, in particular, the x-ray tubes are relatively expensive, the conveyor belt is divided up into longitudinal strips when a single x-ray tube is used. If, for example, the conveyor belt has a width of 2000 mm, then this is divided up into four longitudinal strips each having a width of 500 mm. As soon as each strip has been examined and evaluated, the x-ray tube is displaced by 500 mm. A 2000 mm wide conveyor belt would then be recorded completely over its entire width in four steps.

Opposite the radiation source, that is, on the other side of the conveyor belt, the rays are detected by sensors which also comprise light-sensitive chips. In order to obtain a good resolution, for example of 3 mm, line sensors are preferably used. The sensor can also act as an individual sensor or as a sensor chain. The dimension of a sensor depends in particular on according to which of the two aforementioned Variants I or II the radiation source covers the extent of the conveyor belt width. In the case of Variant II, a displaceable sensor can be used.

The intensity of the received rays in conjunction with the subsequent evaluation of the gray values by means of specific image processing software permits conclusions to be drawn about the condition of the conveyor belt.

The data from the points deviating from the satisfactory condition of the conveyor belt is finally evaluated in real time and automatically leads to fault messages, for example via individual threshold value data filters. In addition, the data is evaluated graphically.

By using the apparatus of the invention, the following data can be acquired:

(a) detection of cord defects, edge defects and other damage; and,

(b) detection of the cord pitch, cord position, inclusions (air, foreign bodies), belt width, belt thickness, position and condition of the transverse reinforcement, fabric butt joints, (longitudinal and transverse), position and condition of integrated components (conductor loops, transponders, bar codes, et cetera).

### BRIEF DESCRIPTION OF THE DRAWINGS

The invention will now be described with reference to the drawings wherein:

FIG. 1 shows details of a housing with an integrated radiation source and an integrated sensor;

FIG. 2 shows an arrangement of a housing according to FIG. 1 upstream of the vulcanizing press (before the vulcanization);

FIG. 3 shows an arrangement of a housing according to FIG. 1 downstream of the vulcanizing press (after the vulcanization);

FIG. 4 is a side elevation view of the housing 1 viewed in the direction of arrow IV in FIG. 1;

FIG. 5 is a schematic showing the process computer connected to the sensor and radiation source including the control device for the radiation source; and,

FIG. 6 shows a housing wherein the radiation source is movably mounted on a rail so as to be stepwise displaceable transversely to the direction of movement of the conveyor belt.

### DESCRIPTION OF THE PREFERRED EMBODIMENTS OF THE INVENTION

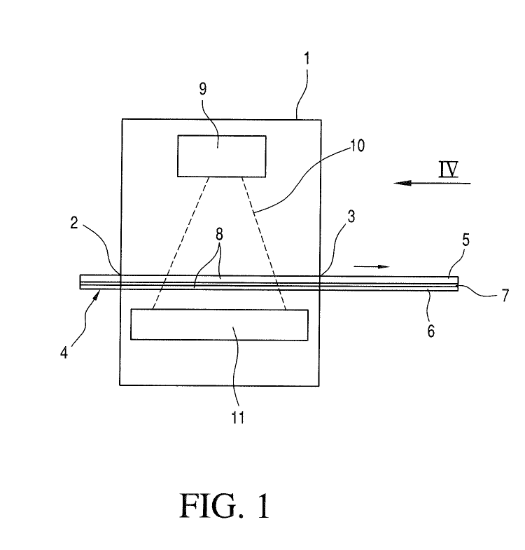

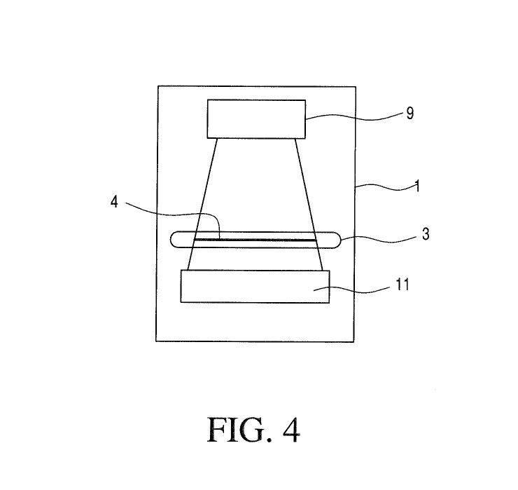

FIG. 1 shows a housing 1 which has two housing openings 2 and 3, through which the conveyor belt 4 is guided in the running direction (arrow direction) without contact. The two housing openings (2, 3) are normally formed as appropriately large wide slots as shown in FIG. 4 wherein housing opening 3 is shown. The conveyor belt has a carrying-side cover plate 5 and a running-side cover plate 6 and each cover plate comprises a rubber mixture, for example based on CR. In addition, a tension member or reinforcement 7, for example in the form of steel cords, is embedded in the conveyor belt. Apart from these basic components, the conveyor belt can also have transverse reinforcement, conductor loops, transponders, et cetera. The conveyor belt is still unvulcanized here (conveyor belt blank) and still has air inclusions 8 within the carrying-side and running-side cover plates.

A radiation source 9, in particular in the form of an x-ray tube, is accommodated within the housing 7. The radiation source with its high-energy rays 10, in particular in the form of x-rays, covers the carrying-side cover plate 5. With regard to the measurement, reference is made to the two Variants I and II described herein. A sensor 11, which is arranged in the immediate vicinity of the running-side cover plate 6, detects the rays 10 that have passed through, without contact (that is, without any wear). The sensor is formed in particular in this case as a line sensor. A process computer 30 finally evaluates the result of the radiographic check, for example the extent of the air inclusions 8.

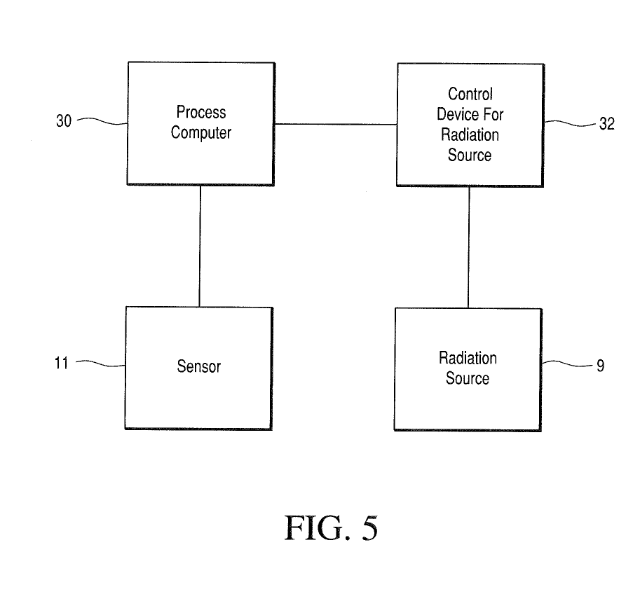

As FIG. 5 shows, the process computer 30 is connected to the sensor 11. The computer 30 is coupled with the radiation source 9 including its control device 32.

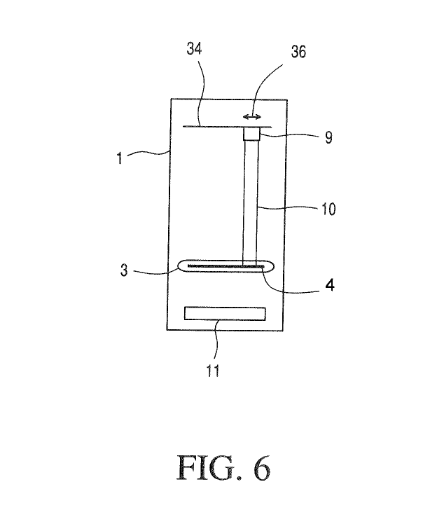

For large overland conveyor belts, which are generally up to 2,800 mm wide, the conveyor belt 4 can be thought of as being divided up into several longitudinal strips. The x-ray tube is displaced by incremental amounts so that the longitudinal strips are covered sequentially. Thus, referring to FIG. 6, the radiation source 9 is movably mounted on a rail 34 so as to be stepwise displaceable in the directions of double arrow 36 transversely to the direction of movement of the conveyor belt 4. This configuration will permit the rays to be directed sequentially toward corresponding ones of the longitudinal strips.

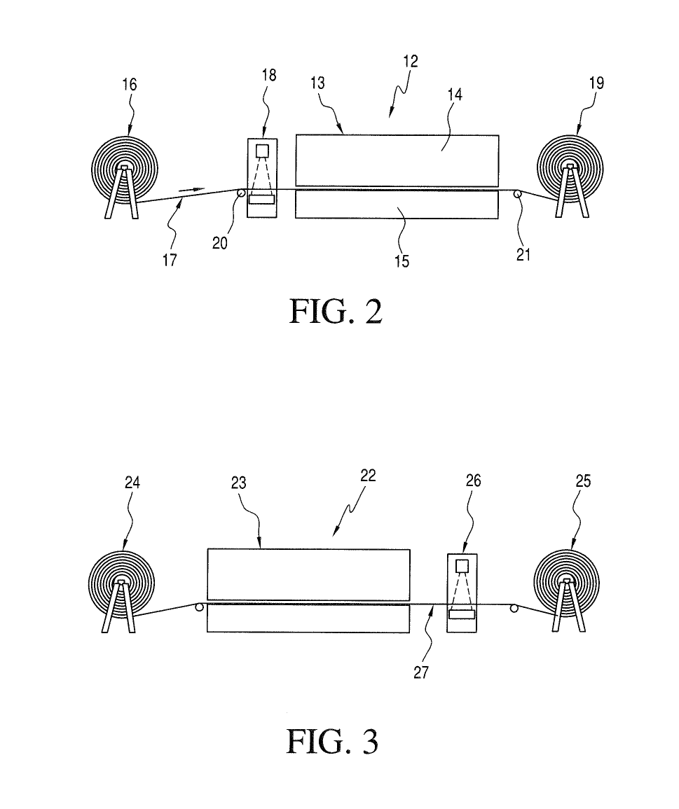

FIG. 2 shows a production plant 12 having a vulcanizing press 13 comprising an upper platen 14 and a lower platen 15 which can be heated. The vulcanization temperature is usually 130 to 180° C.

The unvulcanized conveyor belt blank is stored on a first winding unit 16 following its production. When unwinding the conveyor belt 17, this blank is fed to the vulcanizing press 13 in the running direction (arrow direction) for the purpose of vulcanization.

Upstream of the vulcanizing press 13, there is arranged a housing 18, as described in more detail within the context of FIG. 1. The housing 18 is in this case normally sunk into the floor of the production hall, underneath the conveyor belt 17. In this housing, the radiographic check of the conveyor belt blank is carried out with evaluation by means of a process computer. In addition, the state of the conveyor belt blank can be followed by a camera by using an image, in particular a radiograph. If the actual values agree with the set values while considering limit values, the conveyor belt blank examined in this way is transferred into the vulcanizing press and vulcanized there. The transfer into the vulcanizing press can even be carried out when there are deviations from the set values which can be rectified within the context of the vulcanization. This is possible, for example, if the result of the radiographic check is that the conveyor belt blank has air inclusions 8 (FIG. 1) which deviate from the relevant set values or limit values. By adapting the vulcanization conditions, the air inclusions can be minimized, at least within the scope of the limit value range.

A second winding unit 19 finally receives the vulcanized conveyor belt by rolling the latter up. This rolled up and finished conveyor belt can then be transported to its location of use on a conveyor system.

During the entire production operation between the first winding unit 16 and the second winding unit 19, the conveyor belt 17 outside the vulcanizing press is guided on carrying rollers 20 and 21 or on a roller system. With regard to the winding technique for the conveyor belt, reference is made, for example, to the teaching according to U.S. Pat. No. 7,438,252 incorporated herein by reference.

FIG. 3 shows a production plant 22 having a vulcanizing press 23, a first winding unit 24 and a second winding unit 25. With regard to relevant details, reference is made to the embodiment of FIG. 2. In this production plant, the housing 26 is arranged downstream of the vulcanizing press, where the radiographic check of the vulcanized conveyor belt 27 is carried out within the context of a final article inspection.

The housings 18 (FIG. 2) and 26 (FIG. 3) can also be arranged jointly in a production plant, so that a conveyor belt inspection is conducted before and after the vulcanization.

It is understood that the foregoing description is that of the preferred embodiments of the invention and that various changes and modifications may be made thereto without departing from the spirit and scope of the invention as defined in the appended claims.

### LIST OF REFERENCE NUMERALS

### Part of the Description

1 Housing
2 Housing opening
3 Housing opening
4 Conveyor belt
5 Carrying-side cover plate
6 Running-side cover plate
7 Tension member
8 Air inclusions
9 Radiation source
10 Rays
11 Sensor (detector)
12 Production plant
13 Vulcanizing press
14 Upper platen
15 Lower platen
16 First winding unit
17 Conveyor belt
18 Housing
19 Second winding unit
20 Carrying roller
21 Carrying roller
22 Production plant
23 Vulcanizing press
24 First winding unit
25 Second winding unit
26 Housing
27 Conveyor belt
30 Processor
32 Control device for radiation source
34 Rail
36 Double arrow

What is claimed is:

1. An apparatus for non-destructively inspecting a conveyor belt in a production facility, the conveyor belt defining a belt surface and having a carrying side cover plate and a running side cover plate with each of the cover plates being made of a rubber mixture and having a reinforcement embedded therein, the production facility including: a vulcanizing press having a heatable upper plate and a heatable lower plate for accommodating the conveyor belt therebetween during production thereof; a first winding unit for holding the conveyor belt in an unvulcanized state as a blank and for feeding the conveyor belt to said vulcanizing press by unrolling the conveyor belt from said first winding unit; and, a second winding unit for receiving the conveyor belt after being vulcanized in and after leaving said vulcanizing press; the apparatus comprising:
a housing disposed forward or rearward of said vulcanizing press and including first and second housing openings through which the conveyor belt passes without contact;
a radiation source mounted in said housing for transmitting rays toward said belt surface;
said radiation source being configured to transmit said rays with sufficiently high energy so as to cause said rays to pass through said conveyor belt;
a sensor mounted in said housing for detecting the rays passed through said conveyor belt without contact therewith to facilitate a radiographic check by providing actual values of said conveyor belt; and,
a processor for evaluating said radiographic check by comparing said actual values of said conveyor belt to set values of said conveyor belt.

2. The apparatus of claim 1, wherein said radiation source transmits x-rays.

3. The apparatus of claim 2, wherein said radiation source is an x-ray tube.

4. The apparatus of claim 1, wherein said radiation source is arranged in said housing so as to cause said radiation source to cover the entire width of said conveyor belt.

5. The apparatus of claim 1, wherein said conveyor belt is subdivided into a plurality of imaginary longitudinal strips; and, said radiation source is step-wise displaceable transversely to the direction of movement of said conveyor belt so as to permit said rays to be directed sequentially toward corresponding ones of said longitudinal strips.

6. The apparatus of claim 1, wherein said radiation source is mounted in said housing so as to transmit said rays toward said carrying side cover plate of said conveyor belt and said sensor is mounted in said housing so as to detect rays from said running side cover plate of said conveyor belt.

7. The apparatus of claim 1, wherein said sensor is a line sensor.

8. The apparatus of claim 1, wherein said sensor is a single sensor.

9. The apparatus of claim 1, wherein said sensor comprises a sensor device.

10. The apparatus of claim 1, wherein said first and second openings of said housing are configured to be wide slots.

11. An apparatus for non-destructively inspecting a conveyor belt in a production facility, the conveyor belt defining a belt surface and having a carrying side cover plate and a running side cover plate with each of the cover plates being made of a rubber mixture and having a reinforcement embedded therein, the production facility including: a vulcanizing press having a heatable upper plate and a heatable lower plate for accommodating the conveyor belt therebetween during production thereof; a first winding unit for holding the conveyor belt in an unvulcanized state as a blank and for feeding the conveyor belt to said vulcanizing press by unrolling the conveyor belt from said first winding unit; and, a second winding unit for receiving the conveyor belt after being vulcanized in and after leaving said vulcanizing press; the apparatus comprising:
first and second housings arranged forward and rearward of said vulcanizing press, respectively;
each one of said housings having first and second openings through which the conveyor belt passes without contact;
a radiation source mounted in each of said housings for transmitting rays toward said belt surface;
each one of the radiation sources being configured to transmit said rays with sufficiently high energy so as to cause said rays to pass through said conveyor belt;
a sensor mounted in each one of said housings for detecting the rays passed through said conveyor belt without contact therewith to facilitate a radiographic check by providing actual values of said conveyor belt; and,
a processor for evaluating the radiographic checks by comparing the actual values of said conveyor belt from the sensor in said first housing to first set values of said conveyor belt in said unvulcanized state and by comparing the actual values of said conveyor belt from the sensor in said second housing to second set values of said conveyor belt vulcanized in said vulcanizing press.

12. The apparatus of claim 11, wherein said radiation sources transmit x-rays.

13. The apparatus of claim 12, wherein each of said radiation sources is an x-ray tube.

14. The apparatus of claim 11, wherein each one of said radiation sources is arranged in the housing corresponding thereto so as to cause said one radiation source to cover the entire width of said conveyor belt.

15. The apparatus of claim 11, wherein said conveyor belt is subdivided into a plurality of imaginary longitudinal strips; and, each one of said radiation sources is step-wise displaceable transversely to the direction of movement of said conveyor belt so as to permit said rays to be directed sequentially toward corresponding ones of said longitudinal strips.

16. The apparatus of claim 11, wherein each one of said radiation sources is mounted in the housing corresponding thereto so as to transmit said rays toward said carrying side cover plate of said conveyor belt and the sensor corresponding to said one radiation source is mounted in said corresponding housing so as to detect rays from said running side cover plate of said conveyor belt.

17. The apparatus of claim 11, wherein each one of said sensors is a line sensor.

18. The apparatus of claim 11, wherein each one of said sensors is a single sensor.

19. The apparatus of claim 11, wherein each one of said sensors comprises a sensor device.

20. The apparatus of claim 11, wherein said first and second openings of each of said first and second housings are configured to be wide slots.

21. A production facility for making a conveyor belt defining a belt surface and having a carrying side cover plate and a running side cover plate with each of the cover plates being made of a rubber mixture and having a reinforcement embedded therein, the production facility comprising:
a vulcanizing press having a heatable upper plate and a heatable lower plate for accommodating the conveyor belt therebetween during production thereof;
a first winding unit for holding the conveyor belt in an unvulcanized state as a blank and for feeding the conveyor belt to said vulcanizing press by unrolling the conveyor belt from said first winding unit;
a second winding unit for receiving the conveyor belt after being vulcanized in and after leaving said vulcanizing press;
an apparatus for non-destructively inspecting the conveyor belt; and,
said apparatus including a housing disposed forward or rearward of said vulcanizing press and including first and second housing openings through which the conveyor belt passes without contact; a radiation source mounted in said housing for transmitting rays toward said belt surface; said radiation source being configured to transmit said rays with sufficiently high energy so as to cause said rays to pass through said conveyor belt; a sensor mounted in said housing for detecting the rays passed through said conveyor belt without contact therewith to facilitate a radiographic check by providing actual values of said conveyor belt; and, a processor for evaluating said radiographic check by comparing said actual values of said conveyor belt to set values of said conveyor belt.
